(19) United States
(12) Patent Application Publication
(10) Pub. No.: US 2017/0337752 A1
(43) Pub. Date: Nov. 23, 2017

(54) VEHICLE-LEVEL MULTI-MODAL TEST PLATFORM

(71) Applicant: Panasonic Automotive Systems Company of America, Division of Panasonic Corporation of North America, PEACHTREE CITY, GA (US)

(72) Inventor: JOHN LUKE HOLDREN, FERNDALE, MI (US)

(21) Appl. No.: 15/598,978

(22) Filed: May 18, 2017

Related U.S. Application Data
(60) Provisional application No. 62/340,354, filed on May 23, 2016.

(51) Int. Cl. G07C 5/08; G06F 9/44; G06F 3/16

(52) U.S. Cl. CPC G07C 5/0808; G07C 5/0816; G06F 3/167; G06F 9/4446

(57) ABSTRACT

A multi-modal test arrangement for a motor vehicle includes a memory device storing a test script for testing operation of a portion of the motor vehicle while the vehicle is being driven. The test script requires interaction with a human user of the vehicle while the test script is running. A user interface is permanently installed in the motor vehicle and enables interfacing between the test script and the human user of the vehicle while the test script is running.

### CROSS-REFERENCE TO RELATED APPLICATION

This application claims benefit of U.S. Provisional Application No. 62/340,354 filed on May 23, 2016, which the disclosure of which is hereby incorporated by reference in its entirety for all purposes.

### FIELD OF THE INVENTION

The disclosure relates to a multi-modal test platform for a motor vehicle.

### BACKGROUND OF THE INVENTION

Currently, all validation components depend entirely upon using outside resources including test scripts, computer(s), diagnostic hardware tools, and other peripheral devices that require attention, thus depleting a driver's attention while performing a test. This is especially important when validation activities require the test subject to also be present in the driver's position while the vehicle is in motion. Such is the case with Automatic Speech Recognition and Multi-Modal user interface testing, where it is common for a tester to travel at highway speeds. Because current test methodologies require external peripherals, driver distraction is increased.

A test script is a set of steps that may include machine language or application interface (API) instructions (e.g., calls/responses), or human-readable text, used to set the preconditions for a specific use case, providing steps to execute the test, the expected system interaction, criteria by which to assess a success or failure, and a place to record the final result.

### SUMMARY

The present invention may provide an in-vehicle multi-modal validation system. The embedded test interface may reside within a particular vehicle module or modules, for example a radio head unit (HU), and may accept test scripts that could be loaded to internal memory or read from an external device such as a USB drive, cell phone memory, or computer hard drive. The device or devices interacting directly with the test script (known as the device under test) may contain all components (software, hardware, or otherwise) required to support the interactions. Once loaded, the system may provide a test mode, wherein portions of the vehicle's infotainment controls and displays may become available for interaction with the test interface. Examples of such infotainment controls include steering wheel controls, soft keys, potentiometers, and essentially any available device with which the head unit communicates. Portions of the vehicle's infotainment controls and displays may be made available for interaction with the test interface through the built-in diagnostics mode for whichever communication protocol is in use with a given system (e.g., CAN, LIN, Automotive Ethernet, etc.) or internally on a particular module or modules. Examples of external displays include, but are not limited to, the head unit's internal or external display, the instrument panel cluster (IPC), and the heads up display (HUD). While under test, the system may still acknowledge and respond to any request that carries a higher priority task (e.g., automatic crash notification, chimes, collision detection system requests), after which test system functionality may resume.

During the test, the head unit may present the user with test script instructions and provide an interface to either accept or reject the result of a test. The user interface, in general, may include an HMI (human machine interface), such as steering wheel controls and touch screen keys. All system results associated with a test script may be available in text format using standard logging practices already in place during the software development process.

In one embodiment, the invention comprises a multi-modal test arrangement for a motor vehicle, including a memory device storing a test script for testing operation of a portion of the motor vehicle while the vehicle is being driven. The test script requires interaction with a human user of the vehicle while the test script is running. A user interface is permanently installed in the motor vehicle and enables interfacing between the test script and the human user of the vehicle while the test script is running.

In another embodiment, the invention comprises a multi-modal test method for a motor vehicle, including accessing a test script within the motor vehicle. The test script is run to test operation of a portion of the motor vehicle while the vehicle is being driven. The running of the test script includes interaction with a human user of the vehicle via a user interface permanently installed in the motor vehicle.

In yet another embodiment, the invention comprises a multi-modal test method for a motor vehicle, including loading a test script into the motor vehicle, and running the test script in the motor vehicle. A user interface permanently installed in the motor vehicle is used to instruct a human user to perform a step required to run the test script. It is determined whether an actual result of running the test script matches an expected result of running the test script.

An advantage of the present invention is that, by using the embedded test interface and leveraging existing vehicle systems, displays and controls, the inventive system can greatly reduce the overall workload of the driver/test subject, improving safety, quality of results, and decreasing total test time.

### BRIEF DESCRIPTION OF THE DRAWINGS

A better understanding of the present invention will be had upon reference to the following description in conjunction with the accompanying drawings.

FIG. 1 is a block diagram of one example embodiment of a vehicle level multi-modal test platform of the present invention.

FIG. 2 is a flow chart of one example embodiment of a vehicle level multi-modal test method of the present invention.

FIG. 3 is a flow chart of another example embodiment of a multi-modal test method of the present invention for a motor vehicle.

### DETAILED DESCRIPTION OF THE PREFERRED EMBODIMENTS

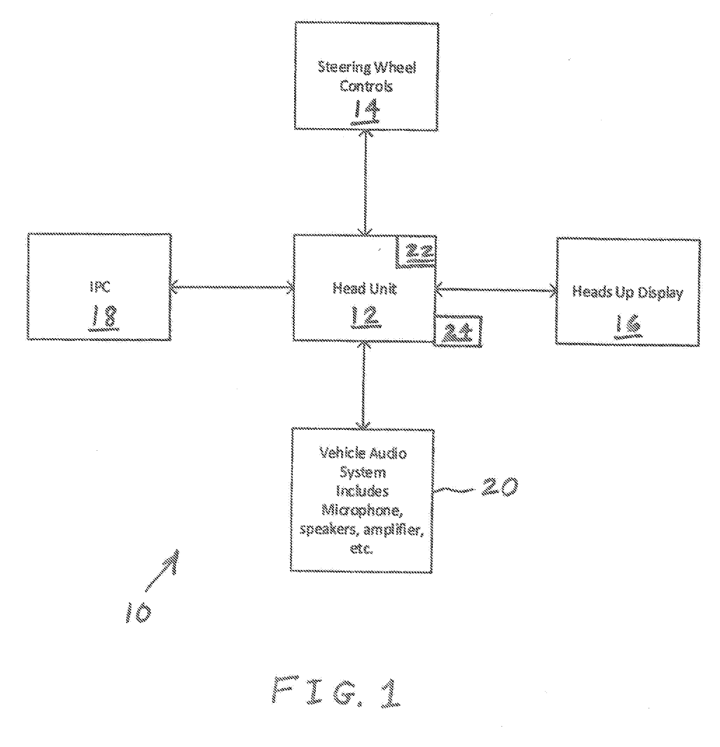

FIG. 1 illustrates one example embodiment of a vehicle level multi-modal test platform 10 of the present invention, including a user interface in the form of a head unit 12 in bidirectional communication with steering wheel controls 14, HUD 16, IPC 18, and a vehicle audio system 20 including a microphone, speakers, amplifier, etc. Platform 10 may provide an embedded test interface which may accept test scripts which may be loaded to an internal memory 22 of head unit 12 or which may be read from an external memory device 24 such as a USB drive, cell phone memory, or computer hard drive. Once loaded, the platform 10 may operate in a test mode, wherein portions of the vehicle's infotainment controls and displays may be used for interaction with the test interface.

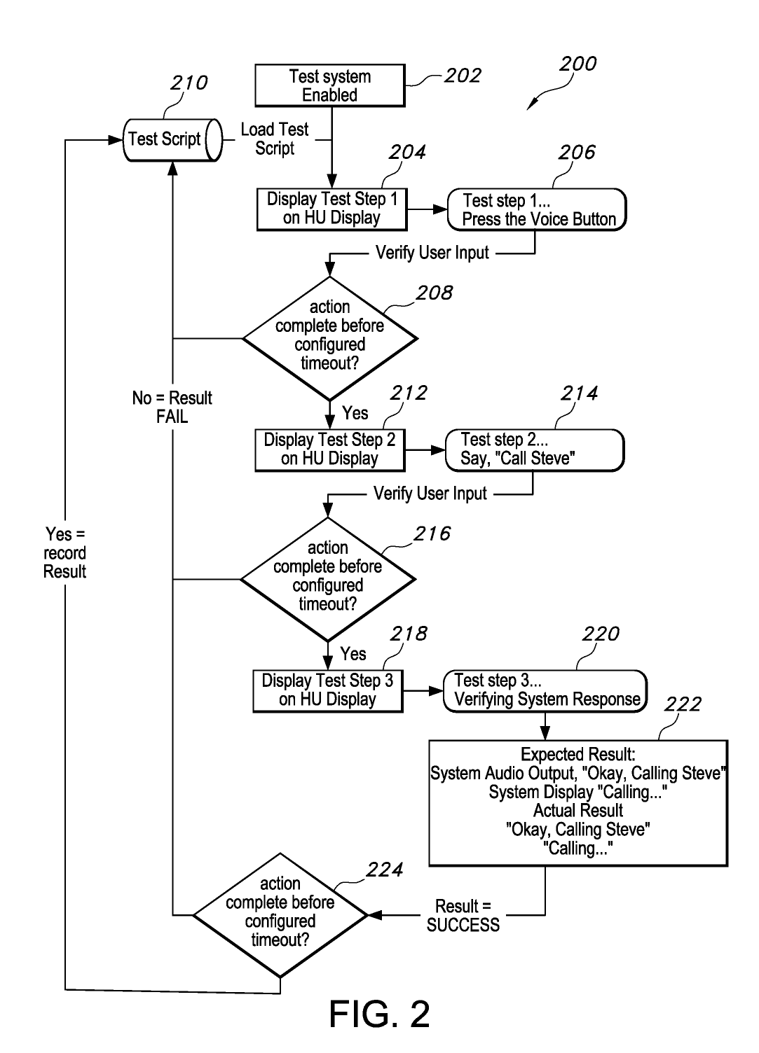

FIG. 2 illustrates one example embodiment of a vehicle level multi-modal test method 200 of the present invention, which may involve use of platform 10. In a first block 202, the test system (e.g., test platform 10) is enabled, and a test script is loaded into the test system (e.g., into internal memory of test platform 10, or through being read by test platform 10 from an external memory device). In a next block 204, a first step of the test script is displayed on a display screen associated with head unit 12. For example, the instruction “Press the voice button” (block 206) may be displayed on the display screen, referring to the driver pressing a voice recognition button on a steering wheel control.

The user input is verified, and in block 208 it is determined whether the action of pressing the voice button has been completed before a configured timeout period of time has elapsed. If not, then the result is that the test has been failed, and operation returns to blocks 210 and 202 wherein a test script is loaded into the test system. Conversely, if the action of pressing the voice button is completed before the expiration of the timeout period, then in block 212 a second step of the test script is displayed on a display screen associated with head unit 12. For example, the instruction “Call Steve” (block 214) may be displayed on the display screen, referring to the driver saying “Call Steve”, and this utterance may be interpreted by an in-vehicle voice recognition system.

The user input is verified, and in block 216 it is determined whether the driver has said “Call Steve” before a configured timeout period of time has elapsed. If not, then the result is that the test has been failed, and operation returns to blocks 210 and 202 wherein a test script is loaded into the test system. Conversely, if the action of saying “Call Steve” is completed before the expiration of the timeout period, then in block 218 a third step of the test script is displayed on a display screen associated with head unit 12. For example, the system response may be verified (block 220), and the results of the verification may he displayed on the display screen, as shown in block 222. In the particular example shown in block 222, it is displayed that the expected result of the test is the system audibly outputting “Okay, calling Steve”, and the system visibly presenting “Calling . . . ” on a display screen. As also indicated in block 222, the actual result of the test matches the expected result, as the system audibly outputs “Okay, calling Steve” and visibly presents “Calling . . . ” on the display screen.

In a final block 224, it is determined whether the action of verifying the system response has been completed before a configured timeout period of time has elapsed. If not, then the result is that the test has been failed, the result may be recorded, and operation returns to blocks 210 and 202 wherein a test script is loaded into the test system. Conversely, if the action of verifying the system response is completed before the expiration of the timeout period, then the result is that the test has been passed, the result is recorded, and operation returns to blocks 210 and 202 wherein a test script is loaded into the test system.

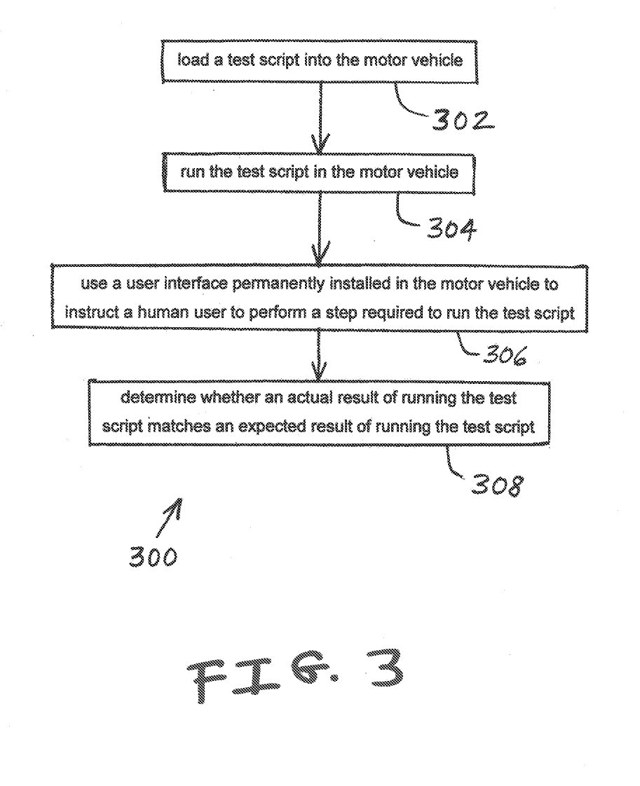

FIG. 3 illustrates another example embodiment of a multi-modal test method 300 of the present invention for a motor vehicle. In a first step 302, a test script is loaded into the motor vehicle. For example, an embedded test interface in platform 10 may accept test scripts which may be loaded to an internal memory 22 of head unit 12.

Next, in step 304, the test script is run in the motor vehicle. For example, an electronic processor within the motor vehicle may execute the steps or code of the test script.

In a next step 306, a user interface permanently installed in the motor vehicle is used to instruct a human user to perform a step required to run the test script. For example, an instruction may be audibly played on an in-vehicle loudspeaker asking the driver to press a certain pushbutton (e.g., a voice recognition pushbutton) associated with a feature to be tested.

In a final step 308, it is determined whether an actual result of running the test script matches an expected result of running the test script. For example, it may be determined whether the action of pressing the voice button has been completed before a configured timeout period of time has elapsed.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A multi-modal test arrangement for a motor vehicle, the arrangement comprising:
a memory device storing a test script for testing operation of a portion of the motor vehicle while the vehicle is being driven, the test script requiring interaction with a human user of the vehicle while the test script is running; and
a user interface permanently installed in the motor vehicle and configured to enable interfacing between the test script and the human user of the vehicle while the test script is running.

2. The multi-modal test arrangement of claim 1 wherein the memory device is permanently installed in the motor vehicle.

3. The multi-modal test arrangement of claim 1 wherein the memory device is a portable memory device communicatively coupled to an electronic processor permanently installed in the motor vehicle.

4. The multi-modal test arrangement of claim 1 wherein the user interface includes a display screen configured to display a text instruction from the test script to the user.

5. The multi-modal test arrangement of claim 4 wherein the user interface includes a microphone configured to detect a response to the text instruction, the response being spoken by the user, the user interface being configured to transmit the detected response to the test script.

6. The multi-modal test arrangement of claim 4 wherein the user interface includes a pushbutton configured to detect a response to the text instruction, the response comprising the user pressing the pushbutton, the user interface being configured to transmit the detected response to the test script.

7. The multi-modal test arrangement of claim 4 wherein the display screen is configured to display a result of the testing of the operation of the portion of the motor vehicle.

8. A multi-modal test method for a motor vehicle, the method comprising: accessing a test script within the motor vehicle; and miming the test script to verify operation of a portion of the motor vehicle while the vehicle is being driven, the running of the test script including interaction with a human user of the vehicle via a user interface permanently installed in the motor vehicle.

9. The method of claim 8 wherein the interaction with the human user includes the human user entering input into the user interface.

10. The method of claim 8 further comprising determining whether the interaction with the human user has occurred within a threshold period of time.

11. The method of claim 10 wherein the threshold period of time is a time period since the user was instructed to perform the interaction.

12. The method of claim 8 wherein the user interface includes a pushbutton, the interaction with a human user comprising the human user pressing the pushbutton.

13. The method of claim 8 wherein the user interface includes a microphone, the interaction with a human user comprising the human user speaking words.

14. The multi-modal test method of claim 12 wherein the user interface includes a display screen, the method further comprising using the display screen to display a text instruction from the test script to the user, the text instruction instructing the user how he should perform the interaction.

15. A multi-modal test method for a motor vehicle, the method comprising:
loading a test script into the motor vehicle;
running the test script in the motor vehicle;
using a user interface permanently installed in the motor vehicle to instruct a human user to perform a step required to run the test script; and
determining whether an actual result of running the test script matches an expected result of running the test script.

16. The method of claim 15 wherein the performance by the human user of the step required to run the test script includes the human user entering input into the user interface.

17. The method of claim 15 further comprising determining whether the human user has performed the step required to run the test script within a threshold period of time.

18. The method of claim 17 wherein the threshold period of time is a time period since the user was instructed to perform the step.

19. The method of claim 15 wherein the user interface includes a pushbutton, the step required to run the test script comprising pressing the pushbutton.

20. The method of claim 15 wherein the step comprises a first step, the user interface including a microphone, the method further comprising using the user interface to instruct the human user to perform a second step required to run the test script, the second step comprising the user speaking words.
